(19) United States
(12) Patent Application Publication
(10) Pub. No.: US 2008/0223624 A1
(43) Pub. Date: Sep. 18, 2008

(54) Bulk Material Storage Container

(75) Inventor: Heinz Hax, Holmdel, NJ (US)

Correspondence Address: DeMont & Breyer, LLC, 100 Commons Way, Ste. 250, Holmdel, NJ, 07733, US

(73) Assignee: SCHENCK PROCESS GMBH, 64293 Darmstadt (DE)

(21) Appl. No.: 11/911,714

(22) PCT Filed: Mar. 8, 2006
(86) PCT No.: PCT/EP06/02103

§ 371 Date: Apr. 25, 2008

(30) Foreign Application Priority Data
Apr. 22, 2005 (DE) 10 2005 018 917.2

(51) Int. Cl. G01G 11/14

(52) U.S. Cl. 177/16

(57) ABSTRACT

The invention relates to a storage container for granular or powdery bulk material. Said container comprises a lower, generally conical discharge element which is provided with a discharge opening for the bulk material, a controlled cut-off device being provided on the discharge opening. In order to allow the discharge quantity of the bulk material to be detected as simply as possible, a weighing module is provided at a discharge end of the cut-off device in relation to the direction of discharge of the bulk material, the flow of bulk material flowing through the weighing module. The weighing module continuously detects the weight of the bulk material discharged through the cut-off device and transmits control signals representing the weight to a control. The control initiates closure of the cut-off device once the added up control signals exceed a defined limit.

The invention relates to an essentially cylindrical storage container for granular or powdery bulk material with a lower, generally conical discharge part provided with a bulk material outlet opening, wherein a controllable cut-off device is arranged on the outlet opening.

Such storage containers or silos are held upright typically by a sturdy foundation at a predetermined height above the ground and usually contain 50 t of bulk material or more, which is stored for filling tanks mounted on trucks. To fill the tanks with bulk material, the truck drives into a precisely predetermined position under the storage container, in which a filling port of the tank is located precisely under the cut-off device. Opening the cut-off device lets the bulk material pour into the tank due to the force of gravity. For space reasons, the vertical distance between the cut-off device and the filling port of the tank should be as small as possible. Because the truck lowers with the increasing fill state of the tank, an expandable component; for example, in the form of a hose, should be inserted between the cut-off device and filling port.

For economical reasons, the maximum carrying capacity of the truck and thus the maximum fill state of the tank should be utilized as much as possible for one filling. For the truck to be safe in traffic, overfilling of the tank must be ruled out absolutely. For this purpose, a preferably electronic controller must detect the current fill state of the tank and must trigger an immediate closing of the cut-off device when the maximum value is reached.

For detecting the fill state, the weight of the bulk material mass in the tank can be used. Therefore, a vehicle scale, on which the truck stands in the mentioned position, is installed in the ground under the storage container. Such a measure, however, means considerable expense, which also becomes worthless if the storage container must be disassembled and rebuilt at a different location due to more important reasons. In addition, it is regulation that the total vehicle weight be known when it first leaves the operating area, where the storage container is located.

Therefore, the invention is based on the task of creating a simpler option for detecting the fill state of the tank.

For the storage container named above, the invention provides that relative to the discharge direction of the bulk material, on the outlet side of the cut-off device, a weighing module is provided, which is run through by the bulk material flow and which continuously detects the weight of the bulk material running through the cut-off device and which feeds weight-representative control signals to a controller, wherein the controller triggers the closing of the cut-off device when a predetermined limiting value is reached by the summed control signals. The invention has the advantage that the weight of the bulk material flowing out of the storage container can be measured directly, that is, not only by means of a separate vehicle scale. In addition, a weighing module is much less expensive and remains permanently on the storage container. Furthermore, typical storage containers can be easily retrofitted through simple measures by means of a weighing module with associated controller.

For the invention, in the simplest case a weighing module can be used, which is described in document DE 102 53 078 B3. The funnel of the weighing module preferably can be mounted directly on the outlet opening of the cut-off device. Especially for powdery bulk material, for example, cement, the positioning of a dedusting device between the cut-off device and weighing module is recommended. It is further advisable to change the housing of the known weighing module so that the bulk material flow leaves the weighing module in axial alignment with the inlet direction.

There are bulk materials for which it is desirable that a second bulk material be added to them in the tank such that a predetermined ratio of the first material to the second material is set in the tank. For this purpose, an advantageous refinement of the invention provides that the weighing module is connected to the cut-off device via a short pipe connector, into which opens a feed from a dosing device containing the second material.

The weighing module then definitely measures the total weight of the bulk material flow composed of the first and second materials. On the other hand, the current weight of the first bulk material flowing through the weighing module is essentially a constant determined by the first material. The controller connected to the weighing module stores both this constant and also the predetermined mixing ratio of the first to the second material. The controller includes a subtracting device, which subtracts the constant from the signal obtained from the weighing module and representing the current weight of the bulk material flow composed of the first and second materials and which compares the subtraction signal with the stored ratio value. The resulting signal of the comparison finally controls the discharge of the second material from the dosing device. This construction of the invention has the advantage that a second material can be mixed continuously in a predetermined ratio to the bulk material from the storage container directly after its cut-off device. A dosing device that is basically suited for this purpose is described in document DE 199 47 516 A1.

For an especially advantageous construction of the invention, a weighing module is recommended, which is refined relative to the weighing module known from the named document in that the Coriolis force measurement device is arranged between a drive shaft driving an impeller wheel deflecting the bulk material flow and a bearing sleeve surrounding this drive shaft. The Coriolis effect can be detected with fine sensitivity so that the error percentage of the weight measurement is at less than 1%. Furthermore, if the drive motor for the drive shaft is arranged preferably laterally next to the drive shaft or the weighing module housing, then the axial overall height of the weighing module can be reduced significantly, that is, to below approximately 100 cm. This embodiment allows not only the dwell time of the grains or powder particles of the bulk material flow in the weighing module to be shortened to less than approximately 100 ms, but also allows the construction of the weighing module on the storage container without increasing its height above the ground. Despite basic inaccuracies, the short dwell time allows a sufficiently precise control of the ratio of the mass flows.

Additional advantageous constructions of the invention are given in the subordinate claims. An embodiment of the invention is described in detail below with reference to the enclosed drawing. Shown are:

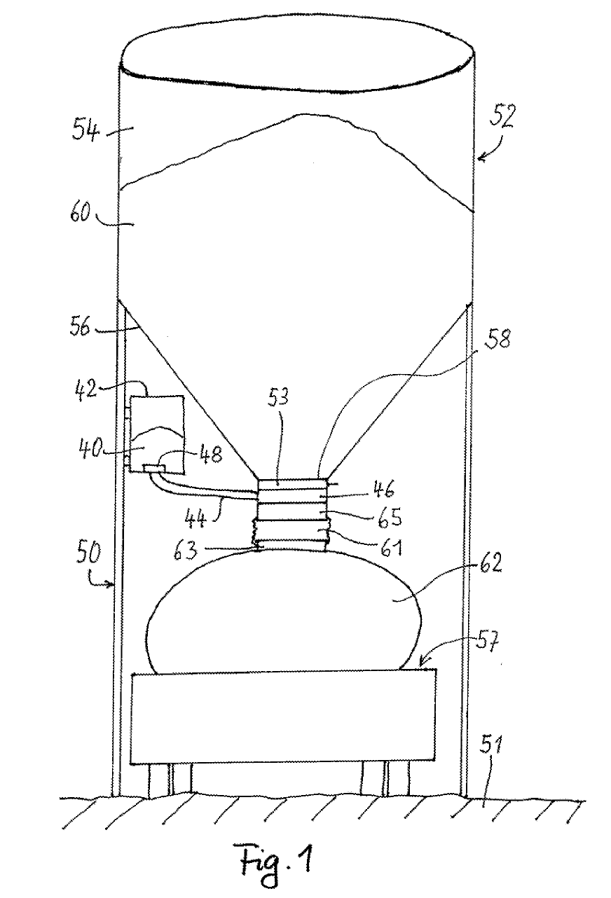

FIG. 1, a schematic representation of a storage container equipped with the features of the invention with a truck standing in position;

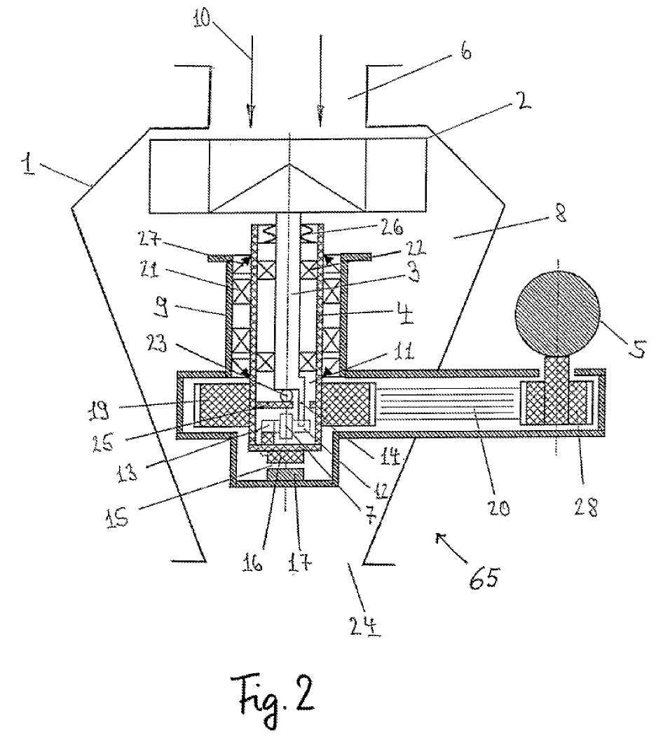

FIG. 2, a schematic representation of a weighing module that is advantageous for the invention; and

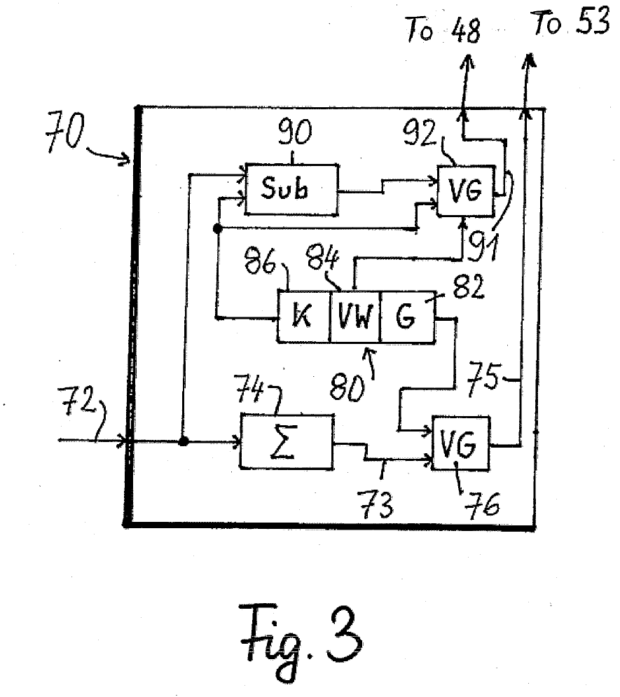

FIG. 3, a schematic representation of a controller with devices that are advantageous for realizing the invention.

A sturdy foundation 50 in the form of supports made from steel or reinforced concrete supports a storage container 52, which has an essentially cylindrical main part 54 and a discharge part 56 running conically downward to an outlet opening 58. The pitch of the cone is naturally selected so that a granular or powdery bulk material 60 contained in the storage container 52 automatically runs through the outlet opening 58 after this outlet opening is opened. In FIG. 1, for explanation only a partial filling of the storage container 52 with bulk material 60 is shown. In practice, the storage container holds masses of bulk material of up to approximately 50 t or more.

The foundation 50 leaves open a drive-through passage 55 under the storage container 52 for a truck 57, which carries along, for example, as a semi-trailer truck, a tank 62 that is to be filled with bulk material 60 from the storage container. Therefore, the foundation 50 must support the storage container 52 at such a height that a drive-through height H for the truck is maintained from the bottom edge of the storage container 52 to the ground 51.

The discharge part 56 is equipped at the outlet opening 58 with a cut-off device 53 in the form of a controllable cut-off valve, which is connected to an expandable hose 61 connecting to a tank fill-in tip 63. According to the invention, the cut-off device 53 is coupled with a weighing module 65 of smaller axial overall height described below. The low overall height is such that the height H is practically not reduced by the weighing module 65.

In FIG. 2, a weighing module for detecting bulk material flows according to the Coriolis principle is shown schematically as a sectional figure. The weighing module 65 essentially has a housing part 1, in which an impeller wheel 2 rotates, and a drive and measurement device arranged underneath, whose drive shaft 3 projects through a driving bearing sleeve 4 into the housing part 1. The bearing sleeve 4 is supported so that it can rotate in a stationary drive housing part 9, wherein a force measurement device 7 is arranged within the bearing sleeve 4 between this sleeve and the drive shaft 3.

During the measurement operation, the bulk material flow 10 is led as a mass flow through an inlet opening 6 in the axial direction to the impeller wheel 2, which is composed of a horizontal plate with radial guide plates and through which the bulk material 10 arriving in the axial direction is deflected radially outward. Through the impeller wheel 2 rotating at a constant rotational speed, the bulk material flow 10 is accelerated outward in the radial direction, wherein a braking moment, which is proportional to the mass flow 10, is generated based on the Coriolis force. For dust-tight measurement operation, the impeller wheel 2 is housed in the enclosed housing part 1, which has in the lower region an outlet opening 24 through which the bulk material 10 is led into the fill-in tip 63 of the truck.

The impeller wheel 2 has a rotationally symmetric construction and a central drive shaft 3, which is arranged vertically and which has on its lower end a driving peg 14 as driving means that is engaged with the force measurement device 7. The drive shaft 3 is surrounded coaxially by the bearing sleeve 4, which runs from the impeller wheel housing space 8 into the drive housing part 9 lying underneath. The bearing sleeve 4 has an essentially tubular construction and extends in axial length past the drive shaft 3 and is closed at its lower cross-sectional surface in the shape of a cylinder. The drive shaft 3 is supported in the bearing sleeve 4 so that it can rotate by means of two cylinder bearings 22 spaced apart from each other as radial bearings. At the lower horizontal end surface of the drive shaft 3, this shaft is supported in the axial direction on a central ball bearing 23, which contacts a crossbar 25 in the bearing sleeve 4 and therefore represents an essentially friction-free axial bearing of the drive shaft 3. Simultaneously, the arrangement of the bearings 22 and 23 guarantees that absolutely no axial or radial interference forces can act on the measurement body 7a of the force measurement device 7. Because the drive shaft 3 can rotate only slightly by at most 5° relative to the bearing sleeve 4, the bearing friction of both the radial bearing 22 and the axial bearing 23 are to be disregarded. The radial bearings can also be constructed as air bearings, in order to improve the bearing friction. As a favorable alternative, a sliding bearing can be provided, which is sufficient especially for measurement devices with lower mass flows. As much as the space requirements permit, the drive shaft 3 can also be supported in the radial direction friction-free by means of a so-called cross-shaped spring element according to DE 103 30 947.0.

At the impeller shaft housing space 8, the drive shaft 3 is protected with a bearing seal 26 against penetrating bulk material. Because the drive shaft 3 rotates only slightly relative to the bearing sleeve 4, a continuously tight connection is provided. Preferably, tightly contacting rubber seals are used, which must be elastic in the rotational direction. For a simplified construction, the drive shaft 3 is mounted by an elastomer on the inner surface of the bearing sleeve 4 both for bulk material sealing and also for radial bearing, wherein elasticity in the rotational direction that is as friction-free as possible is all that must be guaranteed.

The bearing sleeve 4 on its side is also supported by two cylinder bearings 21 in the radial and axial directions so that it can rotate in the stationary drive housing part 9 and is sealed dust-tight by means of a sealing element 27 at the impeller wheel housing space 8. The sealing element 27 can also be integrated into the cylinder bearing 21 or can be constructed as an 0-ring seal. Because neither the cylinder bearing 21 nor the sealing element 27 comes in contact with the measuring drive shaft 3, their friction values are not considered with respect to the measurement, so that these can be dimensioned advantageously such that they exhibit mainly excellent stiffness in the case of the bearing or sealing effect in the case of the sealing element also relative to abrasive bulk material dust.

In the lower drive housing part 9, a gear or pulley 19 is provided as the bearing sleeve drive wheel for the common drive of the drive shaft 3 and the bearing sleeve 4. This drive wheel is arranged like a ring around the lower part of the bearing sleeve 4 and is connected rigidly to it. In the lower drive housing part 9, the drive motor 5 is fixed with a drive wheel 28, which lies on the drive shaft of this drive motor and which is connected to the bearing sleeve drive wheel 19 preferably via a geared belt 20, laterally next to the bearing sleeve drive wheel 19. This motor drive, however, can also be realized by a chain, ribbon, V-belt, or gear drive. This drive motor 5 arranged parallel to the bearing sleeve 4 advantageously allows a horizontal drive, through which a small overall height can be achieved. It is also conceivable, however, to arrange the drive motor 5 directly under the bearing sleeve 4 and to connect to this sleeve via a fixed coupling. Alternatively, the lateral arrangement allows a housing 1, in which the inlet openings 6 and outlet openings 24 lie one above the other in the axial direction and thus can be integrated advantageously in a straight-line vertical feed tube part. As the drive motor 5, an electric motor is provided, which is constructed preferably as a simple asynchronous motor.

In the lower part of the bearing sleeve 4, the force measurement device 7 is arranged and engages with the drive peg 14. The force measurement device 7 is constructed as a force sensor or as a weighing cell and transmits the drive force from the driving bearing sleeve 4 to the drive shaft 3 and is therefore arranged directly between these parts. In the embodiment, a double cantilever beam sensor is provided as a force measurement device 7, which, however, could also be replaced by a rotationally symmetric weighing cell or a torque sensor. For this purpose, preferably rotationally symmetric torque sensors with spoke-like deformation bodies are used as the torque sensor, on which strain gauge strips are arranged, which can be attached coaxial to the drive shaft 3 or in its extension between this shaft and the bearing sleeve 4. Because the double cantilever beam 7 that is used is constructed as a strain gauge strip sensor, the braking moment proportional to the mass flow is detected by a slight tangential deflection of the double cantilever beam, wherein measurement paths on the weighing cell of 0.1 to 0.5 mm are typical. Therefore, the drive shaft 3 rotates essentially in sync with the sleeve rotational speed, wherein between both a maximum rotational angle of 5° is possible. Here, the force measurement device 7 is arranged preferably symmetric to the common rotational axis of the drive shaft 3 and bearing sleeve, wherein the drive peg 14 is supported so that it pivots on the double cantilever beam.

The drive shaft 3 could also be led out at the bottom from the bearing sleeve 4 through a bore hole, wherein the force measurement device 7 could then be housed in a separate sleeve part with enlarged inner diameter as compared to the hollow bodies connected to this device.

Underneath the force measurement device 7 there is also a telemetry device 15, by means of which the measurement signals can be transmitted from the force sensor 7 to an evaluation device in a contactless way. For this purpose, the force sensor 7 is connected to an inductive transmitter device 16, through which the measurement signals are transmitted inductively to an inductive receiver device 17 in an opposing arrangement. Simultaneously, the inductive receiver device 17 is used for transmitting the supply voltage to the transmitter device 16, which is used for powering the strain gauge strip in the double cantilever beam. The received measurement signals can then be transmitted by means of a galvanic connection or a wireless transmission path to a not-shown evaluation device, which evaluates and displays and further processes the measurement signals. The transmission of the measurement signals is preferably performed by means of a carrier frequency alternating current or also by infrared transmission.

The stationary housing part 9 has an essentially cylindrical construction and is installed in the stationary impeller wheel housing part 1, wherein the motor housing part is led laterally out of the impeller wheel housing part 1 and represents a part of the drive housing part 9. The impeller wheel housing part contains on its upper side the inlet opening 6, which preferably contains a connection flange that can be screwed to a feed tube. In the through-flow direction, the impeller wheel housing 1 has a conical construction and in this way spaced away from the drive housing part 9 so far that the flowing bulk material is fed vertically in the axial direction from the inlet opening 6 to the outlet opening 24 lying underneath, which also can be connected to a feed tube. Therefore, advantageously, measurement device heights starting at 250 mm are possible, with which feed amounts of 20 t per hour can be measured. With overall heights starting at 900 mm, constructions up to 600 t per hour can be realized.

The function of the measurement device is described in more detail with reference to the drawing. In the no-load operation, when no bulk material is led onto the impeller wheel 2, only a drive moment or a braking moment, which corresponds to the friction in the measurement section, must be applied by the bearing sleeve 4. Because no friction is generated in this part of the drive section by the bearing sleeve 4 rotating in sync with the drive shaft 3, only the bearing friction caused by vibrations or small rotational speed deviations are applied by the bearing sleeve 4. The friction generated in this part is relatively small because the drive shaft 3 moves the bearing sleeve 4 only very slightly due to such forces and little friction can also appear through the cylinder bearing 22. A corresponding no-load torque is therefore generated only due to air turbulence on the impeller wheel 2, which is compensated by a buoyancy of the measurement device, so that a high zero-point consistency is produced by the nearly friction-free drive shaft bearing 22.

Now if a bulk material flow 10 is discharged in the axial direction onto the impeller wheel 2, the deflection produces a radial acceleration of the bulk material flow 10, which generates an additional braking moment, which is directly proportional to the mass flow due to a Coriolis force on the drive shaft 3. Therefore, the force measurement device 7 engaged with the drive shaft 3 is deflected tangentially a maximum of 0.1 to 0.5 mm and this braking moment is transmitted from the drive shaft 3 to the double cantilever beam sensor 7. The force detected by the double cantilever beam sensor 7 thus represents a value for the mass or bulk material flow 10 running via the impeller wheel 2. By means of the known geometrical dimensions of the impeller wheel 2 and also the lever arm lengths on the double cantilever beam sensor 7, with the help of a not-shown evaluation device, the feed strength or feed amount of the mass flow running via the impeller wheel 2 can be determined and displayed.

Theoretically, for a constant drive rotational speed of the impeller wheel 2, the required drive torque between the impeller wheel 2 and its drive is exactly proportional to the mass flow rate. This is also influenced in practice by additional braking moments produced due to friction forces in the measurement section. This problem is solved by the inventive measure that all of the friction forces are completely eliminated in the measurement section for the drive shaft support at the transition to the impeller wheel housing space 8. This is achieved in that directly between the drive shaft 3 and the bearing sleeve 4 there is the force measurement device 7, by means of which nearly no relative movement is produced between the drive shaft 3 and the bearing sleeve 4, so that the drive shaft 3 is supported friction-free along its entire length up to the force measurement device 7. This also does not concern, in particular, the type of rotating radial bearing 22 between the drive shaft 3 and the bearing sleeve 4, so that simple bearings can also be provided. In contrast, the invention displaces the friction forces to the region between the outer jacket of the bearing sleeve 4 and the stationary drive housing part 9. Therefore, in principle the drive shaft 3 is decoupled from friction forces up to the impeller wheel housing space 8 because the friction-loaded axial and radial bearings 21 of the sleeve 4 are not arranged in the measurement section up to the force measurement device 7. Therefore, it is almost excluded that friction forces at the bearing seal 26 and bulk material dust possibly occurring there can influence the measurement accuracy. Therefore, temperature fluctuations in the bulk material also occurring in this region are not considered, in principle, for the measurement accuracy, because in this way the bearing friction between the bearing sleeve 4 and the drive housing part 9 definitely does fluctuate, but this does not affect the detectable drive moment that acts on the double cantilever beam sensor 7 in the measurement section. Therefore, friction-loaded sealing elements 27, which guarantee a continuous seal for bulk materials with very abrasive dust portions, can also be provided advantageously at the bearing 21 between the bearing sleeve 4 and the drive housing part 9.

In particular, through the friction-free drive shaft bearing according to the invention, which simultaneously guarantees, through its arrangement, that absolutely no axial or radial interference forces act on the measurement bodies, the measurement accuracy for small mass flows 10 also improves because the relatively high impeller wheel rotational speeds that are then necessary also tend for small bulk material deviations and non-uniform impeller wheel loading toward relatively strong unbalanced masses, which cannot act here in the measurement section. In addition, such a friction-free bearing of the measurement section allows a relatively small diameter of the bearing sleeve drive wheel 19 in comparison with the impeller wheel diameter, through which a higher measurement signal sensitivity is to be achieved because braking moment deviations caused by friction in the measurement section are minimized. Therefore, a high zero-point consistency is guaranteed also for small bulk material flows 10.

The controller 70 has a programmable ROM 80, whose section 82 stores a total weight of bulk material to be stored by the tank 62. At the input 72, the controller 70 receives the appropriate current measurement signals from the weighing module 65, which are summed in a summing device 74 over the entire filling process. The resulting sum signal is fed via line 73 to a comparison device 76 and is compared in this with the total weight signal taken from the section 82. The comparison result signal is fed or transmitted as a control signal via the output line 75 of the comparison device 76 to the cut-off device 53, if the cut-off device 53 has a receiver device for the control signal.

If a second pourable material 40 is to be added to the bulk material 60, which is composed of a first material, from a dosing device 42 during the filling process, the dosing device 42 is connected via a tube piece 44 to a short port 46, which is inserted between the cut-off device 53 and the inlet funnel of the weighing module 65. Furthermore, the dosing device has a controllable discharge valve 48.

Typically, or also according to official regulations, the mixing ratio of the first material to the second material is a fixed parameter for the filling process. This parameter is stored as a ratio signal in a section 84 of the memory 80 in the controller 70. In this case, the weighing module 65 measures the current weight of the flowing bulk material flow, which is composed of the first and the second materials. Therefore, the current weight signal is fed from the weighing module 65 by the input 72 of a subtraction device 90 into the controller 70, in which the constant taken from a section 86 of the memory 80 is subtracted from the weight signal. The material-dependent constant is determined empirically from the weight signal of the bulk material flow, which contains only the first material. The output signal from the subtraction device 90 is fed together with the comparison signal taken from the section 84 to a comparison device 92, whose resulting output signal is fed or transmitted as a control signal via line 91 to the control input of the discharge valve 48 of the dosing device 42, if the dosing device has available a receiver device. In this way, the maintenance of the mixing ratio can be guaranteed also for deviating bulk material flow from the storage container 52.

1. Storage container for granular or powdery bulk material with a lower, generally conical discharge part (56) provided with a bulk material outlet opening (58), wherein a controllable cut-off device (53) is arranged at the outlet opening, characterized in that relative to the discharge direction of the bulk material, on the outlet side of the cut-off device (53) there is a weighing module (65), which is run through by the bulk material flow and which continuously detects the weight of the bulk material running through the cut-off device and which feeds weight-representative control signals to a controller (70), wherein the controller triggers the closing of the cut-off device (53) when a predetermined limiting value is reached by the summed control signals.

2. Container according to claim 1, characterized in that the inlet funnel of the weighing module is fixed directly onto the outlet opening of the cut-off device.

3. Container according to claim 1, characterized in that a dedusting device is connected between the cut-off device and the weighing module.

4. Container according to claim 1, characterized in that the bulk material flow leaves the weighing module in axial alignment to the inlet direction of the bulk material flow into the weighing module.

5. Container according to claim 1, characterized in that the weighing module is connected via a short pipe connector (46) to the cut-off device (53), into which a feed (44) opens from a dosing device (42).

6. Container according to claim 5, characterized in that it contains a bulk material composed of a first material and the dosing device contains a bulk material composed of a second material, which is added to the first material in a predetermined mixing ratio.

7. Container according to claim 6, characterized in that the ratio value of the mixing ratio is stored in the controller and a dosing valve (48) controls the dosing device.

8. Container according to claim 5, characterized in that the controller has a subtraction device (90), in which a constant is subtracted from the current weight of the bulk material flow obtained from the weighing module, and the subtraction signal is compared in a comparison device (90) with the stored ratio value and the resulting signal of the comparison controls the discharge of the second material from the dosing device (42).

9. Container according to claim 1, characterized in that a Coriolis force measurement device (7) is arranged in the weighing module between a drive shaft (3) driving an impeller wheel deflecting the bulk material flow and a bearing sleeve (4) surrounding this shaft.

10. Container according to claim 9, characterized in that the drive motor (5) for the drive shaft (3) is arranged laterally next to the drive shaft or the weighing module housing.

11. Container according to claim 9, characterized in that the force measurement device (7) is arranged within the bearing sleeve (4) or within a hollow body connected to the bearing sleeve.

12. Container according to claim 9, characterized in that the force measurement device (7) is constructed as a cantilever beam sensor, as a rotationally symmetric weighing cell, or as a torque sensor.

13. Container according to claim 9, characterized in that the force measurement device (7) detects the drive moment applied by the bearing sleeve (4).

14. Container according to claim 9, characterized in that the force measurement device (7) is fixed with its force sensing part (13) on a part arranged in the inner region (11) of the bearing sleeve (4) and in that the drive shaft (3) is supported with drive means (14) at a distance from the point of rotation on the force introduction part (12) and detects the torque between the bearing sleeve and the drive shaft.

15. Container according to claim 9, characterized in that the force measurement device (7) is connected to a telemetry device (15), which is composed of a transmitter device (16) arranged on the bearing sleeve (4) and a receiver device (17) arranged on the stationary drive housing part (9) and by means of which at least the detected measurement signals can be transmitted.

16. Container according to claim 9, characterized in that the transmitter (16) and receiver devices (17) contain inductors, which are arranged relative to each other so that through their inductive coupling, with the help of alternating currents, both the measurement signals and also the supply voltage for the force measurement device can be transmitted.

17. Container according to claim 9, characterized in that the bearing sleeve is connected via a drive device (19, 20, 28) to a motor (5), wherein the motor is arranged laterally next to or directly under the bearing sleeve (4).

18. Container according to claim 9, characterized in that the drive device contains a drive wheel (19), which is attached to the bearing sleeve and which is connected via a belt (20), chain, or gear drive to the laterally arranged electric motor, which is used for driving the impeller wheel (2).

19. Container according to claim 9, characterized in that in the stationary drive housing part (9), the bearing sleeve is arranged so that it can rotate and projects into the impeller wheel housing (8) and rotates in sync with the constant impeller wheel rotational speed.

20. Container according to claim 9, characterized in that the bearing sleeve (4) is supported by bearings in the radial and axial directions in the drive housing part (9).

21. Container according to claim 9, characterized in that the drive shaft (3) carrying the impeller wheel (2) is supported so that it can rotate in the bearing sleeve, wherein the drive shaft is supported in terms of driving on a force measurement device (7), so that the drive shaft rotates at the same rotational speed due to the driving bearing sleeve.

22. Container according to claim 9, characterized in that the drive shaft (3) is supported by a radial bearing (22) or a cross-shaped spring element relative to the bearing sleeve (4).

23. Container according to claim 9, characterized in that the drive shaft is supported in the axial direction relative to the bearing sleeve by a central axial bearing (23), wherein no axial forces can act on the measurement body.

24. Container according to claim 9, characterized in that the stationary drive housing part (9) has an axial cylindrical construction and is surrounded by an impeller wheel housing (1) tapering upward like a cone and contains inlet (6) and outlet openings (24) lying one above the other in the axial direction in the straight through-flow direction, wherein the drive motor (5) is arranged in parallel laterally next to the drive housing part (9) outside the impeller wheel housing.

25. Container according to claim 9, characterized in that the force measurement device (7) is connected in terms of signals to the controller (70), which calculates the feed amount of the bulk material flow through the weighing module from the detected measurement signals, the geometric dimensions, and other physical parameters.
